(19) United States
(12) Patent Application Publication
(10) Pub. No.: US 2018/0096531 A1
(43) Pub. Date: Apr. 5, 2018

(54) HEAD-MOUNTED DISPLAY AND INTELLIGENT TOOL FOR GENERATING AND DISPLAYING AUGMENTED REALITY CONTENT

(71) Applicant: DAQRI, LLC, Los Angeles, CA (US)

(72) Inventors: Philip Andrew Greenhalgh, Battle (GB); Adrian Stannard, East Sussex (GB); Bradley Hayes, Rye (GB); Colm Murphy, Ovens (IE)

(21) Appl. No.: 15/282,961

(22) Filed: Sep. 30, 2016

(51) Int. Cl. G06T 19/00; G06F 3/01; G06F 3/03; G06K 9/00; H04N 5/247; G02B 27/01

(52) U.S. Cl. CPC G06T 19/006; G06F 3/012; G06F 3/0304; G02B 2027/0141; H04N 5/247; G02B 27/0172; G02B 2027/014; G06K 9/00892

(57) ABSTRACT

A system for displaying augmented reality content includes an intelligent tool and a wearable-computing device. The intelligent tool is configured to obtain at least one measurement of an object using at least one sensor mounted to the intelligent tool, and communicate the at least one measurement to a device in communication with the intelligent tool. The intelligent tool may further include a camera, and the at least one measurement includes an image acquired with the at least one camera. The intelligent tool may also include a biometric module configured to obtain a biometric measurement from a user of the intelligent tool. One or more modules of the intelligent tool may be powered based on the biometric measurement. The wearable-computing device includes a display affixed to the wearable-computing device, such that augmented reality content based on the obtained at least one measurement is displayed on the display.

### TECHNICAL FIELD

The subject matter disclosed herein generally relates to integrating an intelligent tool with an augmented reality-enabled wearable computing device and, in particular, to providing one or more measurements obtained by the intelligent tool to the wearable computing device for display as augmented reality content.

### BACKGROUND

Augmented reality (AR) is a live direct or indirect view of a physical, real-world environment whose elements are augmented (or supplemented) by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

Some embodiments are illustrated by way of example and not limited to the figures of the accompanying drawings.

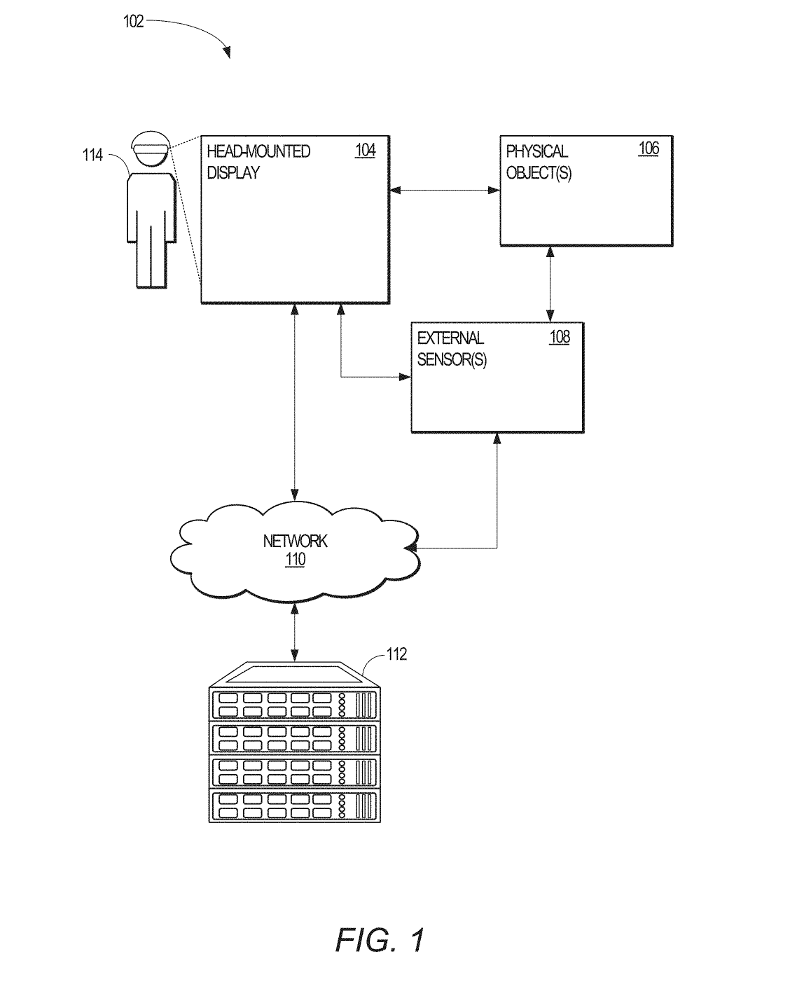

FIG. 1 is a block diagram illustrating an example of a network environment suitable for an augmented reality head-mounted display (HMD), according to an example embodiment

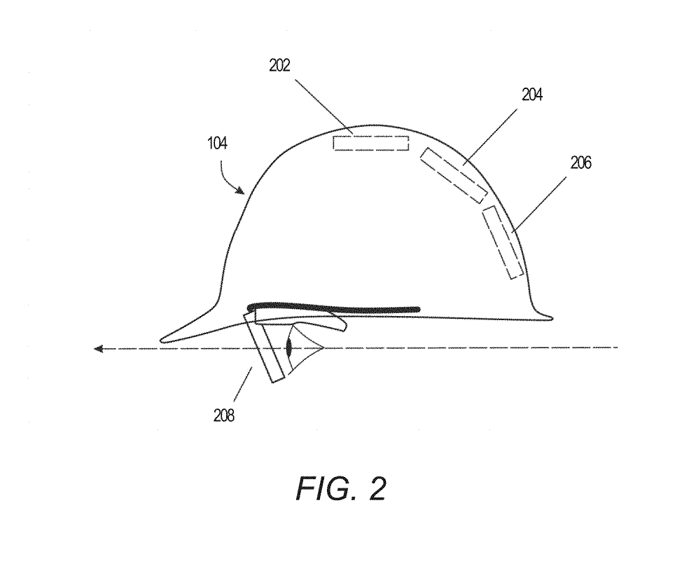

FIG. 2 is a block diagram illustrating various components of the HMD of FIG. 1. according to an example embodiment.

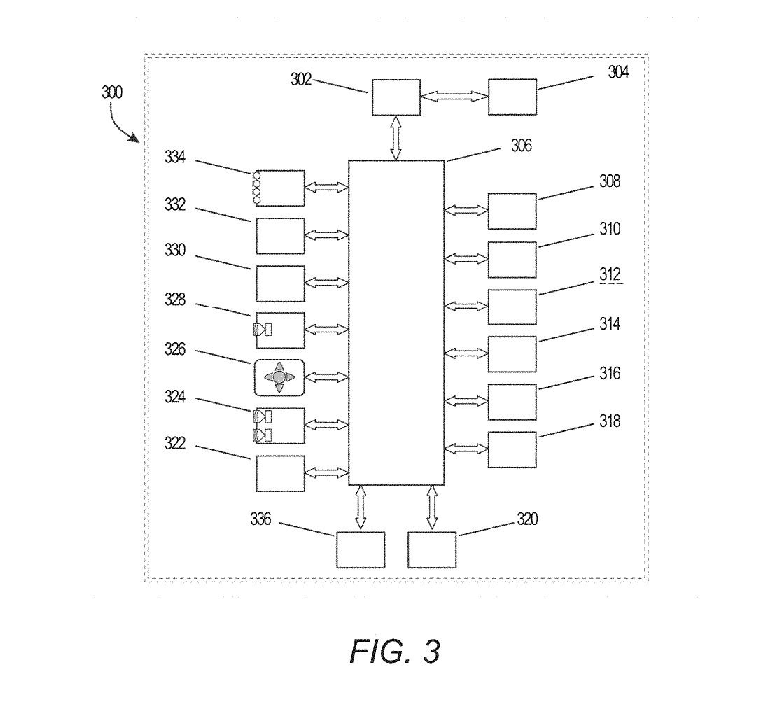

FIG. 3 is a system diagram of the components of an intelligent tool that communicates with the HMD of FIG. 2, according to an example embodiment.

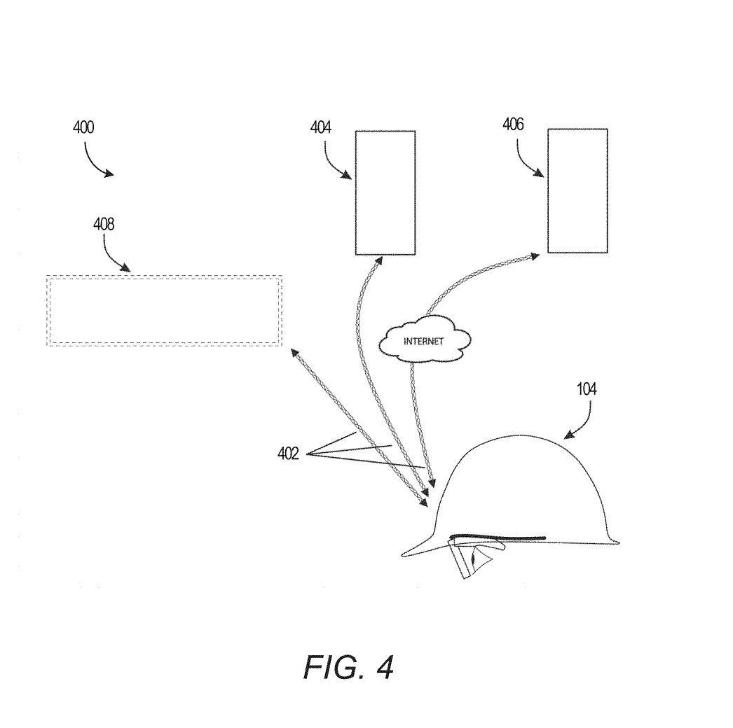

FIG. 4 is a system schematic of the HMD of FIG. 2 and the intelligent tool of FIG. 3, according to an example embodiment.

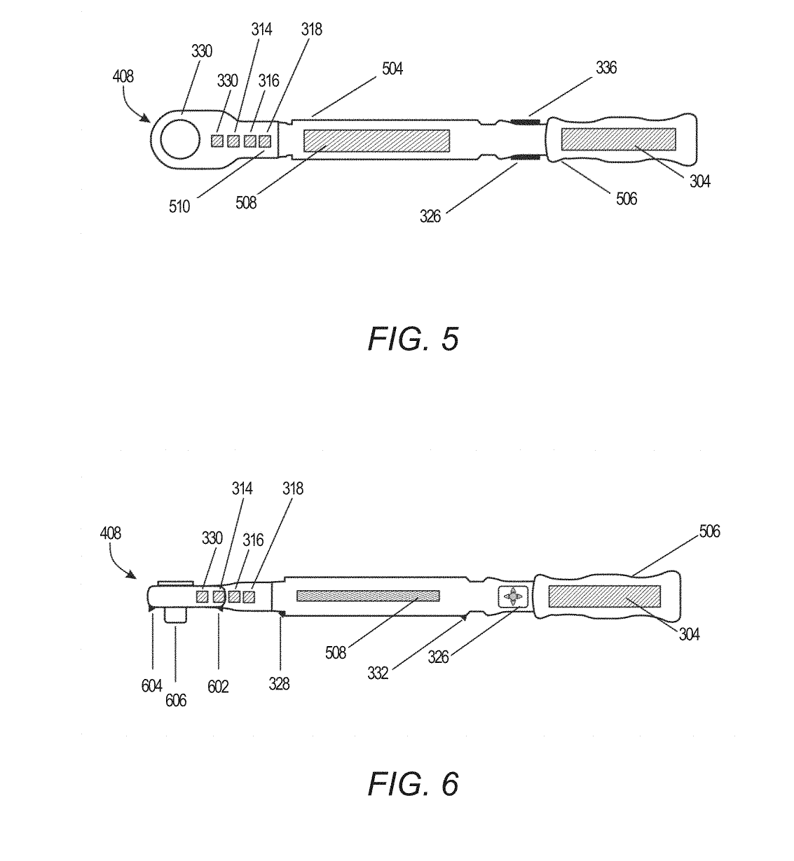

FIG. 5 illustrates a top-down view of an intelligent torque wrench that interacts with the HMD of FIG. 2, according to an example embodiment.

FIG. 6 illustrates a left-side view of the intelligent torque wrench of FIG. 5, according to an example embodiment.

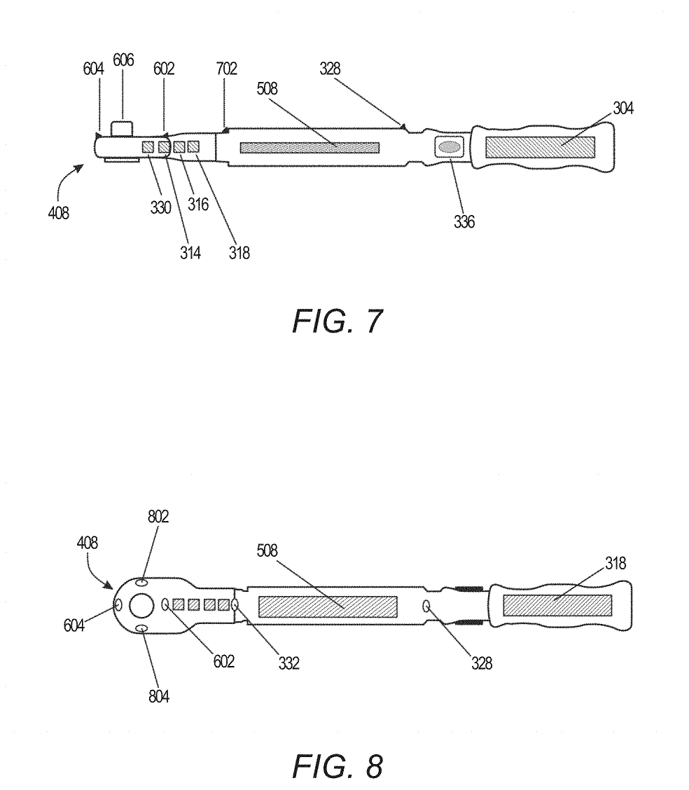

FIG. 7 illustrates a right-side view of the intelligent or e wrench of FIG. 5, according to an example embodiment.

FIG. 8 illustrates a bottom-up view of the intelligent torque wrench of FIG. 5, according to an example embodiment.

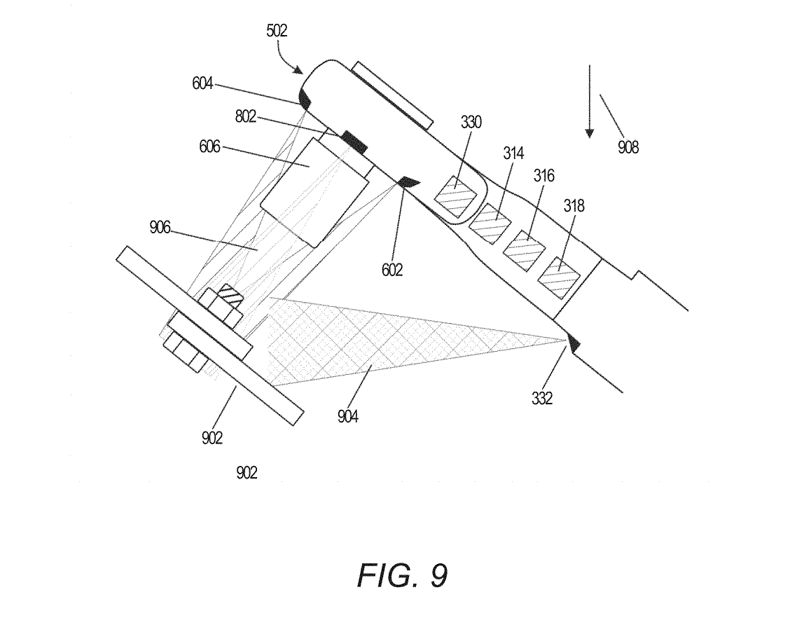

FIG. 9 illustrates a close-up view of the ratchet head of the intelligent torque wrench of FIG. 5, in accordance with an example embodiment.

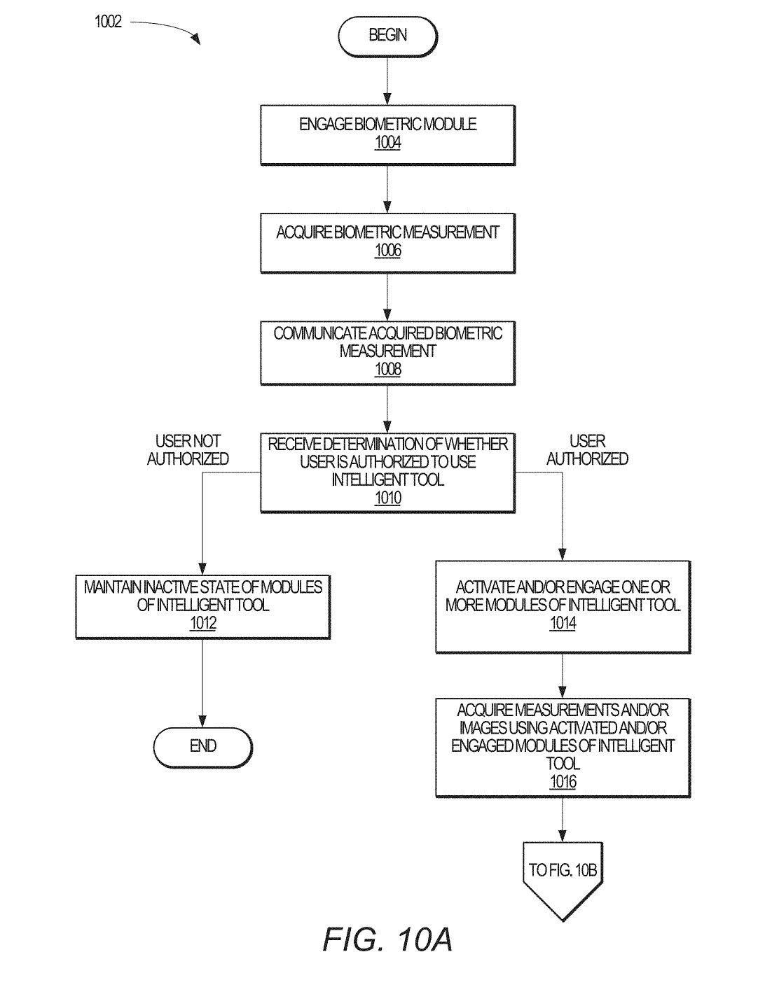

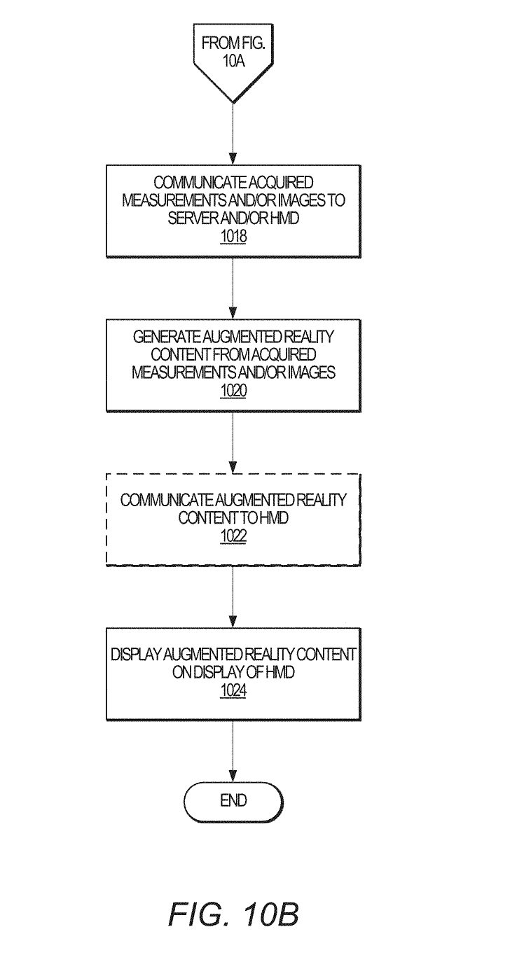

FIGS. 10A-10B illustrate a method, in accordance with an example embodiment, for

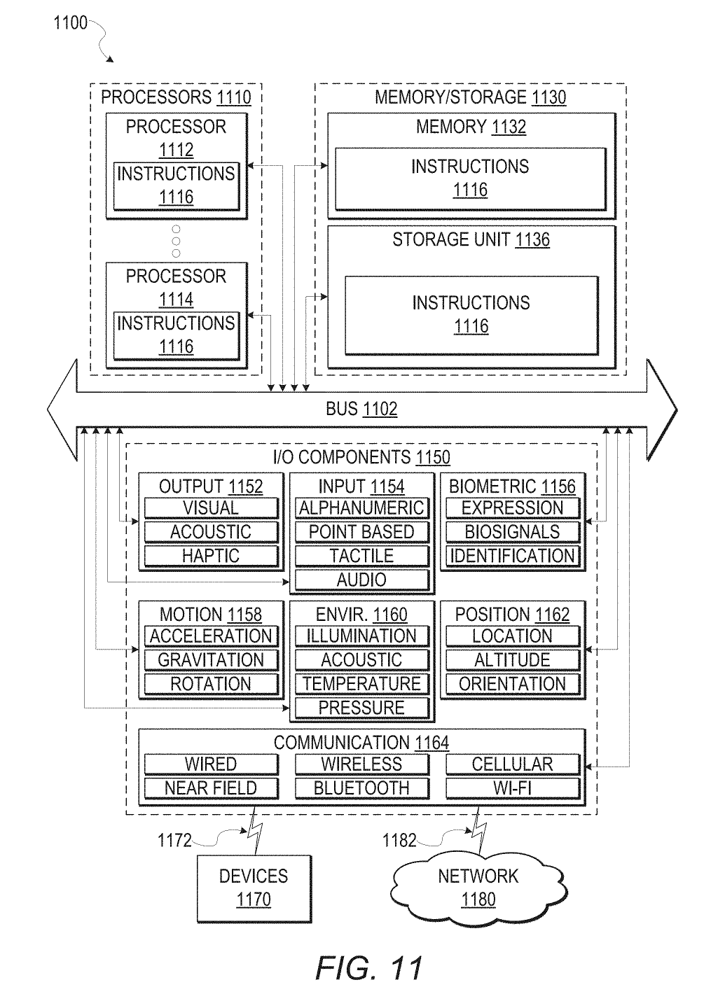

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

This disclosure provides for an intelligent tool that interacts with a head-mounted display (HMD), where the HMD is configured to display augmented reality content based on information provided by the intelligent. In one embodiment, a system for displaying augmented reality content includes an intelligent tool configured to obtain at least one measurement of an object using at least one sensor mounted to the intelligent tool, and communicate the at least one measurement to a device in communication with the intelligent tool. The system also includes a head-mounted display in communication with the intelligent tool, the head-mounted display configured to display, on a display affixed to the head-mounted display, augmented reality content based on the obtained at least one measurement.

In another embodiment of the system of claim, the device comprises the head-mounted display.

In a further embodiment of the system, the device comprises a server in communication with the intelligent tool and the head-mounted display.

In yet another embodiment of the system, the at least one sensor includes a camera and the at least one measurement comprises an image acquired with the at least one camera.

In yet a further embodiment of the system, the augmented reality content is based on the image acquired with the at least one camera.

In another embodiment of the system of claim, the intelligent tool further includes a biometric module configured to obtain a biometric measurement from a user of the intelligent tool, and the intelligent tool is configured to provide electrical power to the at least one sensor in response to a determination that the user is authorized to use the intelligent tool based on the biometric measurement.

In a further embodiment of the system, the at least sensor comprises a plurality of cameras, and the intelligent tool is further configured to acquire a plurality of images using the plurality of cameras, and communicate the plurality of images to the device for generating the augmented reality content displayed by the head-mounted display.

In yet another embodiment of the system, the augmented reality content comprises a three-dimensional image displayable by the head-mounted display, the three-dimensional image constructed from one or more of the plurality of images.

In yet a further embodiment of the system, the intelligent tool comprises an input interface, and the input interface is configured to receive an input from a user that controls the at least one sensor.

In another embodiment of the system of claim, the at least one sensor comprises a camera configured to acquire a video that is displayable on the display of the head-mounted display as the video is being acquired.

This disclosure further describes a computer-implemented method for displaying augmented reality content, the computer-implemented method comprising obtaining at least one measurement of an object using at least one sensor mounted to an intelligent tool, communicating the at least one measurement to a device in communication with the intelligent tool, and displaying, on a head-mounted display in communication with the intelligent tool, augmented reality content based on the obtained at least one measurement.

In another embodiment of the computer-implemented method, the device comprises the head-mounted display.

In a further embodiment of the computer-implemented method, the device comprises a server in communication with the intelligent tool and the head-mounted display.

In yet another embodiment of the computer-implemented method, the at least one sensor includes a camera and the at least one measurement comprises an image acquired with the at least one camera.

In yet a further embodiment of the computer-implemented method, the augmented reality content is based on the image acquired with the at least one camera.

In another embodiment of the computer-implemented method, the computer-implemented method includes obtaining a biometric metric from a user of the intelligent user using a biometric module mounted to the intelligent tool, and providing electrical power to the at least one sensor in response to a determination that the user is authorized to use the intelligent tool based on the biometric measurement.

In a further embodiment of the computer-implemented method, the at least sensor comprises a plurality of cameras, and the computer-implemented method includes acquiring a plurality of images using the plurality of cameras, and communicating the plurality of images to the device for generating the augmented reality content displayed by the head-mounted display.

In yet another embodiment of the computer-implemented method, the augmented reality content comprises a three-dimensional image displayable by the head-mounted display, the three-dimensional image constructed from one or more of the plurality of images.

In yet a further embodiment of the computer-implemented method, the method includes receiving an input, via an input interface mounted to the intelligent tool, that controls the at least one sensor.

In another embodiment of the computer-implemented method, the at least one sensor comprises a camera, and the method further comprises acquiring a video that is displayable on the display of the head-mounted display as the video is being acquired.

FIG. 1 is a block diagram illustrating an example of a network environment 102 suitable for an HMD 104, according to an example embodiment. The network environment 102 includes the HMD 104 and a server 112 communicatively coupled to each other via a network 110. The HMD 104 and the server 112 may each be implemented in a computer system, in whole or in part, as described below with respect to FIG. 11.

The server 112 may be part of a network-based system. For example, the network-based system may be or include a cloud-based server system that provides additional information, such as three-dimensional (3D) models or other virtual objects, to the HMD 104.

The HMD 104 is one example of a wearable computing device and may be implemented in various form factors. In one embodiment, the HMD 104 is implemented as a helmet, which the user 114 wears on his or her head, and views objects (e.g., physical object(s) 106) through a display device, such as one or more lenses, affixed to the HMD 104. In another embodiment, the HMD 104 is implemented as a lens frame, where the display device is implemented as one or more lenses affixed thereto. In yet another embodiment, the HMD 104 is implemented as a watch (e.g., a housing mounted or affixed to a wrist band), and the display device is implemented as a display (e.g., liquid crystal display (LCD) or light emitting diode (LED) display) affixed to the HMD 104.

A user 114 may wear the HMD 104 and view one or more physical object(s) 106 in a real world physical environment. The user 114 may be a human user (e.g., a human being), a machine user (e.g., a computer configured by a software program to interact with the HMD 104), or any suitable combination thereof (e.g., a human assisted by a machine or a machine supervised by a human). The user 114 is not part of the network environment 102, but is associated with the HMD 104. For example, the HMD 104 may be a computing device with a camera and a transparent display. In another example embodiment, the HMD 104 may be hand-held or may be removably mounted to the head of the user 114. In one example, the display device may include a screen that displays what is captured with a camera of the HMD 104. In another example, the display may be transparent or semi-transparent, such as lenses of wearable computing glasses or the visor or a face shield of a helmet.

The user 114 may be a user of an augmented reality (AR) application executable by the HMD 104 and/or the server 112. The AR application may provide the user 114 with an AR experience triggered by one or more identified objects (e.g., physical object(s) 106) in the physical environment. For example, the physical object(s) 106 may include identifiable objects such as a two-dimensional (2D) physical object (e.g., a picture), a 3D physical object (e.g., a factory machine), a location (e.g., at the bottom floor of a factory), or any references (e.g., perceived corners of walls or furniture) in the real-world physical environment. The AR application may include computer vision recognition to determine various features within the physical environment such as corners, objects, lines, letters, and other such features or combination of features.

In one embodiment, the objects in an image captured by the HMD 104 are tracked and locally recognized using a local context recognition dataset or any other previously stored dataset of the AR application. The local context recognition dataset may include a library of virtual objects associated with real-world physical objects or references. In one embodiment, the HMD 104 identifies feature points in an image of the physical object 106. The HMD 104 may also identify tracking data related to the physical object 106 (e.g., GPS location of the HMD 104, orientation, or distance to the physical object(s) 106). If the captured image is not recognized locally by the HMD 104, the HMD 104 can download additional information (e.g., 3D model or other augmented data) corresponding to the captured image, from a database of the server 112 over the network 110.

In another example embodiment, the physical object(s) 106 in the image is tracked and recognized remotely by the server 112 using a remote context recognition dataset or any other previously stored dataset of an AR application in the server 112. The remote context recognition dataset may include a library of virtual objects or augmented information associated with real-world physical objects or references.

The network environment 102 also includes one or more external sensors 108 that interact with the HMD 104 and/or the server 112. The external sensors 108 may be associated with, coupled to, or related to the physical object(s) 106 to measure a location, status, and characteristics of the physical object(s) 106. Examples of measured readings may include but are not limited to weight, pressure, temperature, velocity, direction, position, intrinsic and extrinsic properties, acceleration, and dimensions. For example, external sensors 108 may be disposed throughout a factory floor to measure movement, pressure, orientation, and temperature. The external sensor(s) 108 can also be used to measure a location, status, and characteristics of the HMD 104 and the user 114. The server 112 can compute readings from data generated by the external sensor(s) 108. The server 112 can generate virtual indicators such as vectors or colors based on data from external sensor(s) 108. Virtual indicators are then overlaid on top of a live image or a view of the physical object(s) 106 in a line of sight of the user 114 to show data related to the physical object(s) 106. For example, the virtual indicators may include arrows with shapes and colors that change based on real-time data. Additionally and/or alternatively, the virtual indicators are rendered at the server 112 and streamed to the HMD 104.

The external sensor(s) 108 may include one or more sensors used to track various characteristics of the HMD 104 including, but not limited to, the location, movement, and orientation of the HMD 104 externally without having to rely on sensors internal to the HMD 104. The external senor(s) 108 may include optical sensors (e.g., a depth-enabled 3D camera), wireless sensors (e.g., Bluetooth, Wi-Fi), Global Positioning System (GPS) sensors, and audio sensors to determine the location of the user 114 wearing the HMD 104, distance of the user 114 to the external sensor(s) 108 (e.g., sensors placed in corners of a venue or a room), the orientation of the HMD 104 to track what the user 114 is looking at (e.g., direction at which a designated portion of the HMD 104 is pointed, e.g., the front portion of the HMD 104 is pointed towards a player on a tennis court).

Furthermore, data from the external senor(s) 108 and internal sensors (not shown) in the HMD 104 may be used for analytics data processing at the server 112 (or another server) for analysis on usage and how the user 114 is interacting with the physical object(s) 106 in the physical environment. Live data from other servers may also be used in the analytics data processing. For example, the analytics data may track at what locations points or features) on the physical object(s) 106 or virtual object(s) (not shown) the user 114 has looked, how long the user 114 has looked at each location on the physical object(s) 106 or virtual object(s), how the user 114 wore the HMD 104 when looking at the physical object(s) 106 or virtual object(s), which features of the virtual object(s) the user 114 interacted with (e.g., such as whether the user 114 engaged with the virtual object), and any suitable combination thereof. To enhance the interactivity with the physical object(s) 106 and/or virtual objects, the HMD 104 receives a visualization content dataset related to the analytics data. The HMD 104 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 110 may be any network that facilitates communication between or among machines (e.g., server 112), databases, and devices (e.g., the HMD 104 and the external sensor(s) 108). Accordingly, the network 110 may be a wired. network, a wireless network (e.g., a mobile or cellular network), or any suitable combination thereof. The network 110 may include one or more portions that constitute a private network, a public network (e.g., the Internet), or any suitable combination thereof.

FIG. 2 is a block diagram illustrating various components of the HMD 104 of FIG. 1, according to an example embodiment. The HMD 104 includes one or more components 202-208. In one embodiment, the HMD 104 includes one or more processor(s) 202, a communication module 204, a battery and/or power management module 206, and a display 208. The various components 202-208 may communicate with each other via a communication bus or other shared communication channel (not shown).

The one or more processors 202 may be any type of commercially available processor, such as processors available from the Intel Corporation, Advanced Micro Devices, Qualcomm, Texas Instruments, or other such processors. Further still, the one or more processors 202 may include one or more special-purpose processors, such as a Field-Programmable Gate Array (FPGA) or an Application Specific Integrated Circuit (AMC). The one or more processors 202 may also include programmable logic or circuitry that is temporarily configured by software to perform certain operations. Thus, once configured by such software, the one or more processors 202 become specific machines (or specific components of a machine) uniquely tailored to perform the configured functions and are no longer general-purpose processors.

The communication module 204 includes one or more communication interfaces to facilitate communications between the HMD 104, the user 114, the external sensor(s) 108, and the server 112. The communication module 204 may also include one or more communication interface to facilitate communications with an intelligent tool, which is discussed further below with reference to FIG. 3.

The communication module 204 may implement various types of wired and/or wired interfaces. Examples of wired communication interfaces include Universal Serial Bus (USB), an I²C bus, an RS-232 interface, an RS-485 interface, and other such wired communication interfaces. Examples of wireless communication interfaces include a Bluetooth® transceiver, a Near Field Communication (NEC) transceiver, an 802.11x transceiver, a 3G (e.g., a GSM and/or CDMA) transceiver, and a 4G (e.g., LTE and/or Mobile WiMAX) transceiver. In one embodiment, the communication module 204 interacts with other components of the HMD 104, external sensors 108, and/or the intelligent tool to provide input to the HMD 104. The information provided by these components may be displayed as augmented reality content via the display 208.

The display 108 may include a display surface or lens configured to display augmented reality content (e.g., images, video) generated by the one or more processor(s) 102. In one embodiment, the display 108 is made of a transparent material (e.g., glass, plastic, acrylic, etc.) so that the user 114 can see through the display 108. In another embodiment, the display 108 is made of several layers of a transparent material, which creates a diffraction grating within the display 108 such that images displayed on the display 108 appear holographic. The processor(s) 102 are configured to display a user interface on the display 108 so that the user 114 can interact with the HMD 104.

The battery and/or power module 106 are configured to supply electrical power to one or more of the components of the HMD 104. The battery and/or power module 106 may include one or more different types of batteries and/or power supplies. Examples of such batteries and/or power supplies include, but are not limited to, alkaline batteries, lithium batteries, lithium-ion batters, nickel-metal hydride (NiMH) batteries, nickel-cadmium (NiCd) batteries, photovoltaic cells, and other such batteries and/or power supplies.

The HMD 104 is configured to communicate with, and obtain information from, an intelligent tool. In one embodiment, the intelligent tool is implemented as a hand-held tool such as a torque wrench, screwdriver, hammer, crescent wrench, or other such tool. The intelligent tool includes one or more components to provide information to the HMD 104. FIG. 3 is a system diagram of the components of the intelligent tool 300 that communicates with the HMD 104 of FIG. 2, according to an example embodiment.

As shown in FIG. 3, the intelligent tool 300 includes various modules 302-336 for obtaining information about an object and/or environment in which the intelligent tool 300 is being used. The modules 302-336 may be implemented in software and/or firmware, and may be written in a computer-programming and/or scripting language. Examples of such languages include, but are not limited to, C, C++, C#, Java, JavaScript, Perl, Python, Ruby, or any other computer programming and/or scripting language now known or later developed. Additionally and/or alternatively, the modules 302-336 may be implemented as one or more hardware processors and/or dedicated circuits such as a microprocessor, ASIC, FPGA, or any other such hardware processor, dedicated circuit, or combination thereof.

In one embodiment, the modules 302-336 include a power management and/or battery capacity gauge module 302, one or more batteries and/or power supplies 304, one or more hardware-implemented processors 306, and machine-readable memory 308.

The power management and/or battery capacity gauge module 302 is configured to provide an indication of the remaining power available in the one or more batters and/or power supplies 304. In one embodiment, the power management and/or battery capacity gauge module 302 communicate the indication of the remaining power to the HMD 104, which displays the communicated indication on the display 208. The indication may include a percentage or absolute value of the remaining power. In addition, the indication may be displayed as augmented reality content and may change in value and/or color as the one or more batters and/or power supplies 304 discharge during the use of the intelligent tool 300.

The one or more batteries and/or power supplies 304 are configured to supply electrical power to one or more of the components of the intelligent tool 300. The one or more batters and/or power supplies 304 may include one or more different types of batteries and/or power supplies. Examples of such batteries and/or power supplies include, but are not limited to, alkaline batteries, lithium batteries, lithium-ion batters, nickel-metal hydride (NiMH) batteries, nickel-cadmium (NiCd) batteries, photovoltaic cells, and other such batteries and/or power supplies.

The one or more hardware-implemented processors 306 may be any type of commercially available processor, such as processors available from the Intel Corporation, Advanced Micro Devices, Qualcomm, Texas Instruments, or other such processors. Further still, the one or more processors 306 may include one or more FPGAs and/or ASICs. The one or more processors 306 may also include programmable logic or circuitry that is temporarily configured by software to perform certain operations. Thus, once configured by such software, the one or more processors 206 become specific machines (or specific components of a machine) uniquely tailored to perform the configured functions and are no longer general-purpose processors.

The machine-readable memory 308 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable memory” should be taken to include a single medium or multiple media (e.g., a centralized or distributed database, or associated caches and servers) able to store the instructions and/or data. Accordingly, the machine-readable memory 308 may be implemented as a single storage apparatus or device, or, alternatively and/or additionally, as “cloud-based” storage systems or storage networks that include multiple storage apparatus or devices. As shown in FIG. 3, the machine-readable memory 308 excludes signals per se.

The modules 302-336 also include a communication module 310, a temperature sensor 312, an accelerometer 314, a magnetometer 316, and an angular rate sensor 318.

The communication module 310 is configured to facilitate communications between the intelligent tool 300 and the HMD 104. The communication module 310 may also be configured to facilitate communications among one or more of the modules 302-336. The communication module 310 may implement various types of wired and/or wired interfaces. Examples of wired 308. communication interfaces include a USB, an I²C bus, an RS-232 interface, an RS-e interface, and other such wired communication interfaces. Examples of wireless communication interfaces include a Bluetooth® transceiver, an NFC transceiver, an 802.11x transceiver, a 3G (e.g., a GSM and/or CDMA) transceiver, and a 4G (e.g., LTE and/or Mobile WiMAX) transceiver.

The temperature sensor 312 is configured to provide a temperature of an object in contact with the intelligent tool 300 or of the environment in which the intelligent tool 300 is being used. The temperature value provided by the temperature sensor 312 may a relative measurement, e.g., measured in Celsius or Fahrenheit, or an absolute measurement, e.g., measured in Kelvins. The temperature value provided by the temperature sensor 312 may be communicated by the intelligent tool 300 to the HMD 104 via the communication module 310. In one embodiment, the temperature value provided by the temperature sensor 312 is displayable on the display 108. Additionally, and/or alternatively, the temperature value is recorded by the intelligent tool 300 (e.g., stored in the machine-readable memory 308) for later retrieval and/or review by the user 114 during use of the HMD 104.

The accelerometer 314 is configured to detect the orientation of the intelligent tool 300 relative to the Earth's gravity. In one embodiment, the accelerometer 314 is implemented as a multi-axis accelerometer, such as a 3-axis accelerometer, with a direct current (DC) response to detect the orientation. The orientation detected by the accelerometer 314 may be communicated to the HMD 104 and displayable as augmented reality content on the display 208. In this manner, the user 114 can view a simulated orientation of the intelligent tool 300 in the event the user 114 cannot physically see the intelligent tool 300.

The magnetometer 316 is configured to detect the orientation of the intelligent tool 300 relative to the Earth's magnetic field. In one embodiment, the magnetometer 316 is implemented as a multi-axis magnetometer, such as a 3-axis magnetometer, with a DC response to detect the orientation. The orientation detected by the magnetometer 316 may be communicated to the HMD 104 and displayable as augmented reality content on the display 208. In this manner, and similar to the orientation provided by the accelerometer 314, the user 114 can view a simulated orientation of the intelligent tool 300 in the event the user 114 cannot physically see the intelligent tool 300.

The angular rate sensor 318 is configured to determine an angular rate produced as a result of moving the intelligent tool 300. The angular rate sensor 318 may be implemented as a DC-sensitive or non-DC-sensitive angular rate sensor 318. The angular rate sensor 318 communicates the determined angular rate to the one or more processor(s) 306, which use the determined angular rate to supply orientation or change in orientation data to the HMD 104.

In addition, the modules 302-336 further include a Global Navigation Satellite System (GNSS) receiver 320, an indicator module 322, a multi-camera computer vision system 324, and an input interface 326.

In one embodiment, the GNSS receiver 320 is implemented as a multi-constellation receiver configured to receive, and/or transmit, one or more satellite signals from one or more satellite navigation systems. The GNSS receiver 320 may be configured to communicate with such satellite navigation systems as Global Positioning Satellite (GPS), Galileo, BeiDou, and Globalnaya Navigazionnaya Sputnikovaya Sistema (GLONASS). The GNSS receiver 320 is configured to determine the location of the intelligent tool 300 using one or more of the aforementioned satellite navigation systems. Further still, the location determined by the GNSS receiver 320 may be communicated to the HMD 104 via the communication module 310, and displayable on the display 208 of the HMD 104. Additionally, and/or alternatively, the user 114 may use the HMD 104 to request that the intelligent tool 300 provide its location. In this manner, the user 114 can readily determine the location of the intelligent tool 300 should the user 114 misplace the intelligent tool 300 or need to know the location of the intelligent tool 300 should a need for the intelligent tool 300 arise.

The indicator module 322 is configured to provide an electrical output to one or more light sources affixed, or mounted to, the intelligent tool 300. For example, the intelligent tool 300 may include one or more light emitting diodes (LEDs) and/or incandescent lamps to light a gauge, indicator, numerical keypad, display, or other such device. Accordingly, the indicator module 322 is configured to provide the electrical power that drives one or more of these light sources. In one embodiment, the indicator module 322 is controlled by the one or more hardware-implemented processors 306, which instructs the indicator module 322 as to the amount of electrical power to provide to the one or more light sources of the intelligent tool 300.

The multi-camera computer vision system 324 is configured to capture one or more images of an object in proximity to the intelligent tool 300 or of the environment in which the intelligent tool 300 is being used. In one embodiment, the multi-camera computer vision system 324 includes one or more cameras affixed or mounted to the intelligent tool 300. The one or more cameras may include such sensors as semiconductor charge-coupled devices (CCDs), complementary metal-oxide-semiconductor (CMOS) sensors, N-type metal-oxide-semiconductor (NMOS) sensors, or other such sensors or combinations thereof. The one or more cameras of the multi-camera computer vision system 324 include, but are not limited to, visible light cameras (e.g., cameras that detect light wavelengths in the range from about 400 nm to about 700 nm), full spectrum cameras (e.g., cameras that detect light wavelengths in the range from about 350 nm to about 1000 nm), infrared cameras (e.g., cameras that detect light wavelengths in the range from about 700 nm to about 1 mm), millimeter wave cameras (e.g., cameras that detect light wavelengths from about 1 mm to about 10 mm), and other such cameras or combinations thereof.

The one or more cameras may be in communication with the one or more hardware-implemented processors 306 via one or more communication buses (not shown). In addition, one or more images acquired by the multi-camera computer vision system 324 may be stored in the machine-readable memory 308. The one or more images acquired by the multi-camera computer vision system 324 may include one or more images of the object on which the intelligent tool 300 is being used and/or the environment in which the intelligent tool 300 is being used. The one or more images acquired by the multi-camera computer vision system 324 may be stored in an electronic file format, such as Graphics Interchange Format (GIF), Joint Photographic Experts Group (JPG/JPEG), Portable Network Graphics (PNG), a raw image format, and other such formats or combinations thereof.

The one or more images acquired by the multi-camera computer vision system 324 may be communicated to the HMD 104 via the communication module 310 on a real-time, or near real-time, basis. Further still, using one or more interpolation algorithms, such as the Semi-Global Block-Matching algorithm or other image stereoscopy processing, the HMD 104 and/or the intelligent tool 300 are configured to recreate a three-dimensional scene from the acquired one or more images. Where the recreation is performed by the intelligent tool 300, the recreated scene may be communicated to the HMD 104 via the communication module 310. The recreated scene may be communicated on real-time basis, a near real-time basis, or on a demand basis when requested by the user 114 of the HMD 104. The HMD 104 is configured to display the recreated three-dimensional scene (and/or the one or more acquired images) as augmented reality content via the display 208. In this manner, the user 114 of the HMD 104 can view a three-dimensional view of the object on which the intelligent tool 300 is being used or of the environment in which the intelligent tool 300 is being used.

The input interface 326 is configured to accept input from the user 114. In one embodiment, the input interface 326 includes a hardware data entry device, such as a 5-way navigation keypad. However, the input interface 326 may include additional and/or alternative input interfaces, such as a keyboard, mouse, a numeric keypad, and other such input devices or combinations thereof. The intelligent tool 300 may use the input from the input interface 326 to adjust one or more of the modules 302-326 and/or to initiate interactions with the HMD 104.

Furthermore, the modules 302-336 include a high resolution imaging device 328, a strain gauge and/or signal conditioner 330, an illumination module 332, one or more microphone(s) 334, and a biometric module 336.

The high resolution imaging device 328 is configured to acquire one or more images and/or video of an object on which the intelligent tool 300 is being used and/or the environment in which the intelligent tool 300 is being used. The high resolution imaging device 328 may include a camera that acquires a video and/or image at a predetermined resolution at or above a given resolution. For example, a high resolution imaging device 328 may include a camera that acquires a video and/or an image having horizontal resolution at or about 4,000 pixels and vertical resolution at or about 2,000 pixels. In one embodiment, the high resolution imaging device 228 is based on an Omnivision OV12890 sensor.

The strain gauge and/or signal conditioner 330 is configured to measure torque for an object on which the intelligent tool 300 is being used. In one embodiment, the strain gauge and/or signal conditioner 330 measures the amount of torque being applied by the intelligent tool 300 in Newton meters (Nm). The intelligent tool 300 may communicate a torque value obtained from the strain gauge and/or signal conditioner 330 to the HMD 104 via the communication module 310. In turn, the HMD 104 is configured to display the torque value via the display 208. In one embodiment, the HMD 104 displays the torque value as augmented reality content via the display 208.

The illumination module 332 is configured to provide variable color light to illuminate a work area and the intelligent tool 300. In one embodiment, the illumination module 332 is configured to illuminate the work area with one or more different colors of light. For example, the illumuniation module 332 may be configured to emit a red light when the intelligent tool 300 is being used at night. This feature helps reduce the effects of the light on the night vision of other users and/or people who may be near, or in proximity to, the intelligent tool 300.

The one or more microphone(s) 334 are configured to acquire one or more sounds of the intelligent tool 300 or of the environment in which the intelligent tool 300 is being used. In one embodiment, the sound acquired by the one or more microphone(s) 334 are stored in the machine-readable memory 308 as one or more electronic files in one or more sound-compatible formats including, but not limited to, Waveform Audio File Format (WAV), MPEG-1 and/or MPEG-2 Audio Layer III (MP3), Advanced Audio Coding (AAC), and other such formats or combination of formats.

In one embodiment, the sound acquired by the one or more microphone(s) 334 is analyzed to determine whether the intelligent tool 300 is being properly used and/or whether there is a consumable part wear on either the object on which the intelligent tool 300 or in a part of the intelligent tool 300. In one embodiment, the analysis is be performed by acoustic spectral analysis using one or more digital Fourier techniques.

The biometric module 336 is configured to obtain one or more biometric measurements from the user 114 including, but not limited to, a heartrate, a breathing rate, a fingerprint, and other such biometric measurements or combinations thereof. In one embodiment, the biometric module 336 obtains the biometric measurement and compares the measurement to a library of stored biometric signatures stored at a local server 406 or a cloud-based server 404. The local server 406 and the cloud-based server 404 are discussed in more detail with reference to FIG. 4 below.

As mentioned with regard to the various modules 302-336, the intelligent tool 300 is configured to communicate with the HMD 104. FIG. 4 is a system schematic 400 of the HMD 104 of FIG. 2 and an intelligent tool 408 according to an example embodiment. The intelligent tool 408 may include one or more components 302-336 illustrated in FIG. 3.

As shown in FIG. 4, the HMD 104 communicates with the intelligent tool 408 using one or more wired and/or wireless communication channels 402. As explained above, each of the HMD 104 and the intelligent tool 408 includes a communication module 204,310, respectively, and the HMD 104 and the intelligent 408 communicate using these communication modules 204,310.

In addition, the HMD 104 and the intelligent tool 408 may communicate with one or more local server(s) 406 and/or remote server(s) 404. The local server(s) 406 and/or the remote server(s) 404 may provide similar functionalities as the server 112 discussed with reference to FIG. 1. More particularly, the local server(s) 406 and/or remote server(s) 404 may provide such functionalities as image processing, sound processing, application hosting, local and/or remote file storage, and one or more authentication services. These services enhance and/or complement one or more of the functionalities provided by the HMD 104 and/or the intelligent tool 408. As explained above with reference to FIG. 3, the intelligent tool 408 may communicate one or more measurements and/or electronic files to a server (e.g., the server 404 and/or the server 406), which performs the analysis and/or processing one the received electronic files. While the intelligent tool 408 may communicate such electronic files directly to the server, the intelligent tool 408 may also communicate such electronic files indirectly using one or more intermediary devices, such as the HMD 104. In this manner, the intelligent 408, the HMD 104, and the servers 404-406 form a networked ecosystem where measurements acquired by the intelligent tool 200 can be transformed into meaningful information for the user 114.

FIG. 5 illustrates a top view of an intelligent tool 408 that interacts with the HMD 104 of FIG. 2, according to an example embodiment. In one embodiment, the intelligent tool 408 is implemented as an intelligent torque wrench. While FIGS. 5-9 illustrate the intelligent 408 as an intelligent torque wrench, one of ordinary skill in the art will appreciate that the intelligent tool 408 may be implemented as other types of tools as well such as a hammer, screwdriver, crescent wrench, or other type of hand-held tool now known or later developed.

As shown in FIG. 5, the intelligent tool 408 includes a ratchet head 502 coupled to a tubular shaft 504. The tubular shaft 504 includes a grip 506 for gripping the intelligent tool 408. In one embodiment, the grip 506 is pressure sensitive such that the grip 506 detects when the user 114 has gripped the tubular shaft 504. For example, the grip 506 may include a piezoelectric, ceramic, or polymer layers and/or transducers inset into the grip 506. One example of an implementation of the grip 506 is discussed in Chen et al., “Handgrip Recognition,” Journal of Engineering, Computing and Architecture, Vol. 1, No. 2 (2007). Another implementation of the grip 506 is discussed in U.S. Pat. App. Pub. No. 2015/0161369, titled “GRIP SIGNATURE AUTHENTICATION OF USER DEVICE.”

As shown in FIG. 5, the intelligent tool 408 includes a ratchet head 502 coupled to a tubular shaft 504. The tubular shaft 504 includes a grip 506 for gripping the intelligent tool 408. one embodiment, the grip 506 is pressure sensitive such that the grip 506 detects when the user 114 has gripped the tubular shaft 504. For example, the grip 506 may include a piezoelectric, ceramic, or polymer layers and/or transducers inset into the grip 506. When the user 114 has gripped the grip 506, the grip 506 detects which portions of the user's hand are in contact with the grip 506. Furthermore, the grip 506 detects the amount of pressure being applied by the detected portions. The combination of the detected portions and corresponding portion form a pressure profile, which the intelligent tool 408 and/or servers 404,406 use to determine which user 114 is handling the intelligent tool 408.

In addition, the tubular shaft 504 may be hollow or have a space formed therein, wherein a printed circuit board 508 is mounted and affixed to the tubular shaft 504. In one embodiment, the printed circuit board 508 is affixed to the tubular shaft 504 using one or more securing mechanisms including, but not limited to, screws, nuts, bolts, adhesives, and other such securing mechanisms and/or combinations thereof. Although not shown in FIG. 5, the tubular shaft 504 may include one or more receiving mechanisms, such as a hole or the like, for receiving the securing mechanisms, which secures the printed circuit board 508 to the tubular shaft 504.

The ratchet head 502 and/or tubular shaft 504 includes one or more openings that allow various modules and sensors to acquire information about an object and/or the environment in which the intelligent tool 408 is being used. The one or more openings may be formed in one or more surfaces of the ratchet head 502 and/or tubular shaft 504. Additionally, and/or alternatively, one or more modules and/or sensors may protrude through one or more surfaces of the ratchet head 502 and/or tubular shaft 504, which allow the user 114 to interact with such modules and/or sensors.

In one embodiment, one or more modules and/or sensors are disposed within a surface of the ratchet head 502. These modules and/or sensors may include the accelerometer 314, the magnetometer 316, the annular rate sensor 318, and/or the signal conditioner 330. The one or more modules and/or sensors disposed within the ratchet head 502 may be communicatively coupled via one or more communication lines ((e.g., one or more wires and/or copper traces) that are coupled to and/or embedded within the printed circuit board 508. The measurements measured by the various one or more modules and/or sensors may be communicated to the HMD 104 via the communication module (not shown) also coupled to the printed circuit board 508.

Similarly, one or more modules and/or sensors may be disposed within the tubular shaft 504. For example, the input interface 326 and/or the biometric module 336 may be disposed within the tubular shaft 504. By having the input interface 326 and/or the biometric module 336 disposed within the tubular shaft 504, the user 114 can readily access the input interface 326 and/or the biometric module 336 as he or she uses the intelligent tool 408. For example, the user may interact with the input interface 326 using one or more digits of the hand holding the intelligent tool 408. As with the modules and/or sensors disposed within the ratchet head 502, the input interface 326 and/or the biometric module 336 are also coupled to the printed circuit board 508 via one or more communication lines (e.g., one or more wires and/or copper traces). As the user manipulates the input interface 326 and/or interacts with the biometric module 336, the input (from the input interface 326) and/or the measurements (acquired by the biometric module 336), may be communicated to the HMD 104 via the communication module (not shown) coupled to the printed circuit board 508. The input and/or measurements may also be communicated to other modules and/or sensors communicatively coupled to the printed circuit board 508, such as where the input interface 326 allows the user 114 to selectively activate one or more of the modules and/or sensors.

To provide electrical power to the various components of the intelligent tool 408 (e.g., the various modules, sensors, input interface, etc.), the intelligent tool 408 also includes the one or more batteries and/or power supplies 304. As shown in FIG. 5, the tubular shaft 504 may also include a space formed within the tubular shaft for mounting and/or securing the one or more batteries and/or power supplies 304 therein. The one or more batteries and/or power supplies 304 may provide electrical power to the various components of the intelligent tool 408 via one or more communication lines that couple the one or more batteries and/or power supplies 304 to the printed circuit board 508.

FIG. 6 illustrates a left-side view of the intelligent torque wrench of FIG. 5, according to an example embodiment. While not illustrated in FIG. 5, the intelligent torque wrench 408 also includes an attachment adaptor 606 for receiving various types of sockets, which can be used to fit the intelligent torque wrench 408 to a given object (e.g., a nut, bolt, etc.).

As shown in FIG. 6, the intelligent torque wrench 408 also includes various cameras communicatively coupled to the printed circuit board 508 for providing video and/or one or more images of an object on which the intelligent torque wrench 408 is being used. In one embodiment, the cameras include a high resolution camera 328, a first ratchet head camera 602, and a second ratchet head camera 604. The high resolution camera 328 may be mounted to, or inside, the tubular shaft 504 via one or more securing mechanisms and communicatively coupled to the printed circuit board 508 via one or more communication channels (e.g., copper traces, wires, etc.). The first ratchet head camera 602 may be mounted at a bottom portion of the ratchet head 502 and the second ratchet head camera 604 may be mounted to a top portion of the ratchet head 502. By mounting the cameras 602,604 at different locations on the ratchet head 502 at a known distance apart, the multi-camera computer vision system 324 can generate a stereoscopic image and/or stereoscopic video using one or more computing vision algorithms, which are known to one of ordinary skill in the art.

The generation of the stereoscopic images and/or video may be performed by the one or more processors 306 of the intelligent tool 408. Additionally, and/or alternatively, the images acquired by the cameras 602,604 may be communicated to another device, such as the server 112 and/or the HMD 104, which then generates the stereoscopic images and/or video. Where the acquired images are communicated to the server 112, the server 112 may then communicate the results of the processing of the acquired images to the HMD 104 via the network 110.

In one embodiment, the information obtained by the cameras 602,604 including the acquired images, acquired video, stereoscopic images, and/or stereoscopic video, may be displayed as augmented reality content on the display 208 of the HMD 104. Similarly, one or more images and/or video acquired by the high resolution camera 328 may also be displayed on the display 208. In this manner, the images acquired by the high resolution camera 328 and the images acquired by the cameras 602,604 may be viewed by the user 114 and allows the user 114 to gain a different, and closer, perspective on the object on which the intelligent tool 408 is being used.

FIG. 7 illustrates a right-side view of the intelligent torque wrench 408 of FIG. 5, according to an example embodiment. The components illustrated in FIG. 7 are similar to one or more components previously illustrated in FIGS. 5-6. In addition, FIG. 7 provides a clearer view of the biometric module 336. In one embodiment, the biometric module 336 is implemented as a fingerprint reader and is communicatively coupled to the printed circuit board 508 via one or more communication channels. As a fingerprint reader, the biometric module 336 is configured to acquire a fingerprint of the user 114 when he or she grips the intelligent tool 408 via the grip 506. When the user 114 grips the intelligent tool 408, a digit of the user's hand (e.g., the thumb) comes into contact with the biometric module 336. In turn, the biometric module 336 obtains the thumbprint or fingerprint and, in one embodiment, communicates an electronic representation of the thumbprint or fingerprint to the server 112 to authenticate the user 114. Additionally, and/or alternatively, the intelligent tool 408 may be configured to perform the authentication of the user 114. Where the user 114 is determined to be authorized to use the intelligent tool 408, the intelligent tool 408 may activate one or more of the modules communicatively coupled to the printed circuit board 508. Where the user 114 is determined not to be authorized, one or more of the modules of the intelligent tool 408 may remain in an inactive or non-active state.

FIG. 8 illustrates a bottom-up view of the intelligent torque wrench 408 of FIG. 5, according to an example embodiment. FIG. 8 illustrates one or more components of the intelligent tool 408 previously illustrated in FIGS. 5-7. In addition, FIG. 8 shows that the ratchet head 502 may further include additional ratchet head cameras 802,804 for acquiring images of an object on which the intelligent tool 408 is being used. In one embodiment, the cameras 602,604,802,804 are spaced equidistant around the periphery of the ratchet head 502 such that cameras 602,604 are mounted along a first axis and cameras 802,804 are mounted along a second axis, where the first axis and second axis are perpendicular. Like the images and/or video acquired by the cameras 602,604, the images and/or video acquired by the cameras 802,804 may be processed to form stereoscopic images and/or video. Further still, such acquired images and/or video may be communicated to the HMD 104 for display on the display 208.

FIG. 9 illustrates a close-up view of the ratchet head 502 of the intelligent torque wrench 408 of FIG. 5, in accordance with an example embodiment. FIG. 9 illustrates various components of the intelligent torque wrench 408 previously discussed with respect to FIGS. 5-8.

FIG. 9 illustrates that the cameras 602,604,802 mounted around the periphery of the ratchet head 502 create a various field of views 906 of an object and a fastener 902. The various field of views 906 result in one or more images being acquired of the object and fastener 902 from different viewpoints. In addition, a light field 904 projected by the illumination module 332 illuminates the surfaces of the object and the fastener 906 to eliminate potential darkened areas and/or shadows. Thus, the light field 904 provides a clearer view of the object and fastener 902 than if the light field 904 was not created.

In addition, and as discussed above, the one or more images can be processed using one or more computing vision algorithms known to those of ordinary skill in the art to create one or stereoscopic images and/or videos. Furthermore, depending on whether the cameras 602,604,802 acquire a depth parameter value indicating the distance of the surfaces of the object and fastener 902 from the ratchet head 502, the acquired images and/or videos may include depth information that can he used by the one or more computing vision algorithms to reconstruct three-dimensional images and/or videos.

FIG. 9 also illustrates a gravitational field vector 908 for the Earth. The one or more modules (e.g., the accelerometer 314, the magnetometer 316, and/or the angular rate sensor 318) may reference the gravitational field vector 908 in providing one or more measurements to the HMD 104.

FIGS. 10A-10B illustrate a method 1002, in accordance with an example embodiment, for obtaining information from the intelligent tool 408 and providing it to the HMD 104. The method 1002 may be implemented by one or more of the components and/or devices illustrated in FIGS. 1-4, and is discussed by way of reference there to.

Referring initially to FIG. 10A, the user 114 may provide power to the intelligent tool 408 to engage the biometric module 326 (Operation 1004). As previously discussed above, the biometric module 326 is configured to obtain one or more biometric measurements from the user 114, which may be used to authenticate the user 114 and confirm that the user 114 is authorized to use the intelligent tool 408. Accordingly, having engaged the biometric module 326, the biometric module 326 acquires the one or more biometric measurements from the user 114 (Operation 1006). In one embodiment, the one or more biometric measurements include a thumbprint and/or fingerprint of the user 114.

The intelligent tool 408 then communicates the obtained one or more biometric measurements to a server (e.g., server 112, server 404, and/or server 406) having a database of previously obtained biometric measurements (Operation 1008). In one embodiment, the server compares the obtained one or more biometric measurements with one or more biometric measurements of users authorized to use the intelligent tool 408. The results of the comparison (e.g., whether the user 114 is authorized to use the intelligent tool 408) are then communicated to the intelligent tool 408 and/or HMD 104. Accordingly, the intelligent tool 408 receives the results of the comparison at Operation 1010. Although one or more of the server 112,404,406 may perform the comparison, one of ordinary skill in the art will appreciate that the comparison may be performed by one or more other devices, such as the intelligent tool 408 and/or the HMD 104.

Where the user is not authorized to use the intelligent tool 408 (e.g., the “USER NOT AUTHORIZED” branch of Operation 1010), the intelligent tool 408 maintains the inactive state, or unpowered, state of one or more of the modules of the intelligent tool 408 (Operation 1012). In this way, because the user 114 is not authorized to use the intelligent tool 408, the user 114 is unable to take advantage of the information (e.g., images and/or measurements) provided by the intelligent tool 408.

Alternatively, where the user 114 is authorized to use the intelligent tool 408 (e.g., the “USER AUTHORIZED” branch of Operation 1010), the intelligent tool 408 engages and/or powers one or more modules (Operation 1014). The user 114 can then acquire various measurements and/or images using the engaged and/or activated modules of the intelligent tool 408 (Operation 1016). The types of measurements and/or images acquirable by the intelligent tool 408 are discussed above with reference to FIGS. 4-9.

Referring next to FIG. 10B, during use of the intelligent tool 408, the intelligent tool 408 may communicate one or more measurements and/or images to a server (e.g., server 112, server 404, and/or server 406) and/or the HMD 104 (Operation 1018). The server and/or HMD 104 may then generate augmented reality content from the received one or more measurements and/or images (Operation 1020). Operation 1022 is optional in this regard where the augmented reality content is generated by the server, in which case, the generated augmented reality content is communicated to the HMD 104. The HMD 104 then displays the generated augmented reality content on the display 208 (Operation 1024).

In this manner, the intelligent tool 408 provides measurements and/or images to the HMD 104, which are used in generating augmented reality content for display by the HMD 104. Unlike conventional tools, the intelligent tool 408 provides information to the HMD 104 that helps the user 114 better understand the object on which the intelligent tool 408 is being used. This information can help the user 114 understand how much pressure to apply to a given object, how much torque to apply to the object, whether there are defects in the object that prevent the intelligent tool 408 from being used a certain way, whether there are better ways to orient the intelligent tool 408 to the object, and other such information. As this information can be visualized in real-time, or near real-time, the user 114 can quickly respond to changing situations or change his or her approach to a particular challenge. Thus, the disclosed intelligent tool 408 and HMD 104 present an improvement over traditional tools and work methodologies.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions may cause the machine to execute the method illustrated in FIGS. 10A-10B. Additionally, or alternatively, the instructions may implement one or more of the modules 202-236 illustrated in FIG. 3 and so forth. The instructions transform the general, non-programmed machine into a particular machine programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment.

The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and. processor 1114 that may execute instructions 1116. The term “processor” is intended to include multi-core processor that may comprise two or more independent processors (sometimes referred to as “cores”) that may execute instructions contemporaneously. Although FIG. 11 shows multiple processors, the machine 1100 may include a single processor with a single core, a single processor with multiple cores (e.g., a multi-core process), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172 respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to he taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A system for displaying augmented reality content, the system comprising:
an intelligent tool configured to:
obtain at least one measurement of an object using at least one sensor mounted to the intelligent tool; and
communicate the at least one measurement to a device in communication with the intelligent tool; and
a head-mounted display in communication with the intelligent tool, the head-mounted display configured to display, on a display affixed to the head-mounted display, augmented reality content based on the obtained at least one measurement.

2. The system of claim 1, wherein the device comprises the head-mounted display.

3. The system of claim 1, wherein the device comprises a server in communication with the intelligent tool and. the head-mounted display.

4. The system of claim 1, wherein the at least one sensor includes a camera and the at least one measurement comprises an image acquired with the at least one camera.

5. The system of claim 4, wherein the augmented reality content is based on the image acquired with the at least one camera.

6. The system of claim 1, wherein the intelligent tool further includes a biometric module configured to obtain a biometric measurement from a user of the intelligent tool; and
the intelligent tool is configured to provide electrical power to the at least one sensor in response to a determination that the user is authorized to use the intelligent tool based on the biometric measurement.

7. The system of claim 1, wherein:
the at least sensor comprises a plurality of cameras;
the intelligent tool is further configured to:
acquire a plurality of images using the plurality of cameras; and
communicate the plurality of images to the device for generating the augmented reality content displayed by the head-mounted display.

8. The system of claim 7, wherein:
the augmented reality content comprises a three-dimensional image displayable by the head-mounted display, the three-dimensional image constructed from one or more of the plurality of images.

9. The system of claim 1, wherein the intelligent tool comprises an input interface; and
the input interface is configured to receive an input from a user that controls the at least one sensor.

10. The system of claim 1, wherein the at least one sensor comprises a camera configured to acquire a video that is displayable on the display of the head-mounted display as the video is being acquired.

11. A computer-implemented method for displaying augmented reality content, the computer-implemented method comprising:
obtaining at least one measurement of an object using at least one sensor mounted to an intelligent tool;
communicating the at least one measurement to a device in communication with the intelligent tool; and
displaying, on a head-mounted display in communication with the intelligent tool, augmented reality content based on the obtained at least one measurement.

12. The computer-implemented method of claim 11, wherein the device comprises the head-mounted display.

13. The computer-implemented method of claim 11, wherein the device comprises a server in communication with the intelligent tool and the head-mounted display.

14. The computer-implemented method of claim 11, wherein the at least one sensor includes a camera and the at least one measurement comprises an image acquired with the at least one camera.

15. The computer-implemented method of claim 14, wherein the augmented reality content is based on the image acquired with the at least one camera.

16. The computer-implemented method of claim 11, further comprising:
obtaining a biometric metric from a user of the intelligent user using a biometric module mounted to the intelligent tool; and
providing electrical power to the at least one sensor in response to a determination that the user is authorized to use the intelligent tool based on the biometric measurement.

17. The computer-implemented method of claim 11, wherein the at least sensor comprises a plurality of cameras; and
the computer-implemented method further comprises:
acquiring a plurality of images using the plurality of cameras; and
communicating the plurality of images to the device for generating the augmented reality content displayed by the head-mounted display.

18. The computer-implemented method of claim 17, wherein:
the augmented reality content comprises a three-dimensional image displayable by the head-mounted display, the three-dimensional image constructed from one or more of the plurality of images.

19. The computer-implemented method of claim 11, further comprising:
receiving an input, via an input interface mounted to the intelligent tool, that controls the at least one sensor.

20. The computer-implemented method of claim 11, wherein the at least one sensor comprises a camera; and
the method further comprises acquiring a video that is displayable on the display of the head-mounted display as the video is being acquired.
